(19) United States
(12) Patent Application Publication
(10) Pub. No.: US 2013/0050596 A1
(43) Pub. Date: Feb. 28, 2013

(54) AUTO-STEREOSCOPIC DISPLAY AND METHOD FOR FABRICATING THE SAME

(71) Applicants: Chang-Ying Chen, Kaohsiung City (TW); Yi-Heng Chou, Hsinchu City (TW); Chang-Shuo Wu, New Taipei City (TW); Fu-Hao Chen, Kaohsiung City (TW)

(72) Inventors: Chang-Ying Chen, Kaohsiung City (TW); Yi-Heng Chou, Hsinchu City (TW); Chang-Shuo Wu, New Taipei City (TW); Fu-Hao Chen, Kaohsiung City (TW)

(73) Assignee: INDUSTRIAL TECHNOLOGY RESEARCH INSTITUTE, Hsinchu (TW)

(21) Appl. No.: 13/467,986

(22) Filed: May 9, 2012

Related U.S. Application Data
(60) Provisional application No. 61/528,766, filed on Aug. 30, 2011.

(30) Foreign Application Priority Data
Jan. 5, 2012 (TW) 101100470

(51) Int. Cl. G02F 1/1335; B05D 5/06; B23P 11/00; G02B 27/22

(52) U.S. Cl. 349/15; 359/462; 427/162; 29/428

(57) ABSTRACT

An auto-stereoscopic display suitable for being viewed by a viewer is provided. The auto-stereoscopic display includes a display panel and an adjustable parallax barrier module. The adjustable parallax barrier module is disposed between the display panel and the viewer. The adjustable parallax barrier module includes a plurality of parallax barrier stacked upon each other. The distances between the display panel and each of the parallax barrier are different. One of the parallax barriers is selected and enabled based on the distance between the viewer and the display panel. Besides, a method of fabricating the auto-stereoscopic display is also provided.

### CROSS-REFERENCE TO RELATED APPLICATION

This application claims the priority benefits of U.S. provisional application Ser. No. 61/528,766, filed on Aug. 30, 2011 and Taiwan application serial no. 101100470, filed on Jan. 5, 2012. The entirety of each of the above-mentioned patent applications is hereby incorporated by reference herein and made a part of this specification.

### BACKGROUND

1. Technical Field

The present disclosure relates to a display panel and a fabricating method thereof, and more particularly to an auto-stereoscopic display and a fabricating method thereof.

2. Description of Related Art

In recent years, continuous advancement of display technologies results in increasing demands on display quality of displays, such as image resolution, color saturation, and so on. In addition to high image resolution and color saturation, auto-stereoscopic displays are developed to meet viewers' visual requirements.

Generally, viewers are requested to keep a pre-determined distance from the auto-stereoscopic display so as to view optimized three dimensional images. In other words, when the distance between the viewer and the auto-stereoscopic display is unequal to the aforesaid pre-determined distance (e.g. greater than or less than the aforesaid pre-determined distance), three dimensional images viewed by the viewer are not optimized. Specifically, when the distance between the viewer and the auto-stereoscopic display changes, image cross-talk is generated and unexpected ghost image is viewed by the viewer easily. Accordingly, the distance between the viewer and the auto-stereoscopic display is limited strictly.

In the conventional multi-view auto-stereoscopic display disclosed in some issued patents, when the distance between the viewers and the multi-view auto-stereoscopic display changes, optimized three dimensional images provided by the multi-view auto-stereoscopic display cannot be viewed by viewers. Specifically, the viewers move forwardly (or backwardly), the distance between the viewers and the multi-view auto-stereoscopic display decreases (or increases) and display quality of the three dimensional images provided by the multi-view auto-stereoscopic display deteriorates. Accordingly, how to get rid of the problem resulted from distance change between the viewer and the auto-stereoscopic display is an important issue to be solved.

### SUMMARY

The disclosure provides an auto-stereoscopic display. In the auto-stereoscopic display, the distance between a display panel and a parallax barrier is adjustable based on the distance between a viewer and the display panel, such that optimized three dimensional images are viewed by the viewer even though the relative position of the viewer and the auto-stereoscopic display changes.

The disclosure provides a method for fabricating an auto-stereoscopic display capable of providing optimized three dimensional images.

The disclosure provides an auto-stereoscopic display suitable for being viewed by a viewer. The auto-stereoscopic display includes a display panel and an adjustable parallax barrier module. The adjustable parallax barrier module is disposed between the display panel and the viewer. The adjustable parallax barrier module comprises a plurality of parallax barriers stacked upon each other. Distances between each one of the parallax barriers and the display panel are different. One of parallax barriers is enabled based on a distance between the viewer and the display panel.

The disclosure further provides a method for fabricating an auto-stereoscopic display. The method includes the following steps. First, a display panel is provided. An adjustable parallax barrier module is formed over the display panel, wherein the adjustable parallax barrier module comprises a plurality of parallax barriers stacked upon each other.

The disclosure provides an auto-stereoscopic display and a method for fabricating the same. In the disclosure, the distance between the display panel and the parallax barrier is adjustable based on the distance between the viewer and the display panel, such that optimized three dimensional images are viewed by the viewer even though the relative position of the viewer and the auto-stereoscopic display changes.

In order to make the aforementioned and other features and advantages of the disclosure more comprehensible, several embodiments accompanied with figures are described in detail below.

### BRIEF DESCRIPTION OF THE DRAWINGS

The accompanying drawings constituting a part of this specification are incorporated herein to provide a further understanding of the disclosure. Here, the drawings illustrate embodiments of the disclosure and, together with the description, serve to explain the principles of the disclosure.

FIG. 1A schematically illustrates an auto-stereoscopic display according to an embodiment of this disclosure.

FIG. 1B schematically illustrates relationship between the display panel and the adjustable parallax barrier module in the auto-stereoscopic display according to an embodiment of this disclosure.

FIG. 2A schematically illustrates an adjustable parallax barrier module according to an embodiment of this disclosure.

FIG. 2B schematically illustrates an adjustable parallax barrier module according to another embodiment of this disclosure.

FIG. 3A schematically illustrates optical behavior of light generated from the display panel when passing through an enabled parallax barrier of the adjustable parallax barrier module.

FIG. 3B and FIG. 3C schematically illustrate optical behavior of light generated from the display panel when passing through a disabled parallax barrier of the adjustable parallax barrier module.

FIG. 4A and FIG. 4B schematically illustrate optical behavior of light generated from the display panel when passing through the adjustable parallax barrier module.

FIG. 5 schematically illustrates an auto-stereoscopic display according to another embodiment of this disclosure.

FIG. 6 schematically illustrates optimized viewing zones of an auto-stereoscopic display.

FIG. 7A and FIG. 7B schematically illustrate auto-stereoscopic displays that provide optimized three dimensional images when the viewer moves backwardly.

FIG. 8 schematically illustrates a method for fabricating an auto-stereoscopic display according to an embodiment of this disclosure.

FIG. 9 schematically illustrates a method for fabricating an adjustable parallax barrier module according to an embodiment of this disclosure.

FIG. 10 schematically illustrates a method for fabricating an adjustable parallax barrier module according to another embodiment of this disclosure.

### EMBODIMENTS

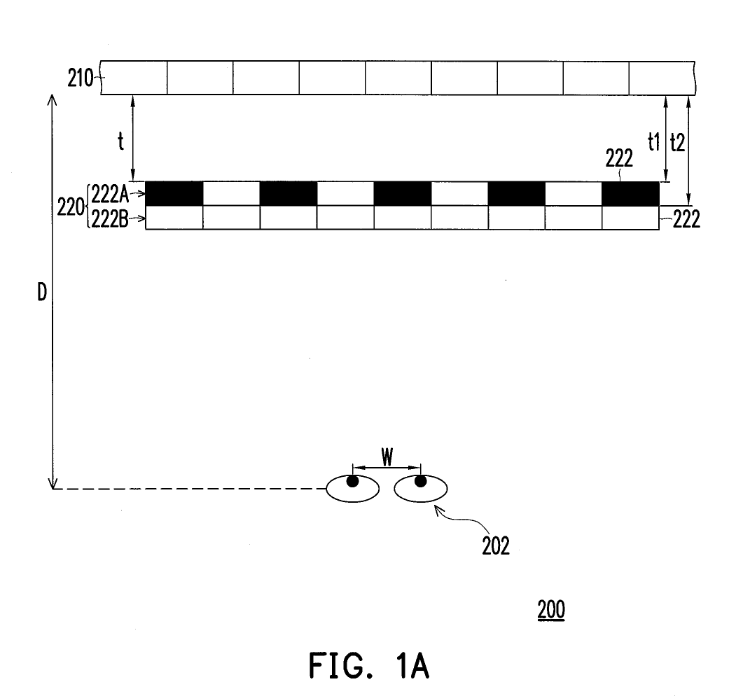

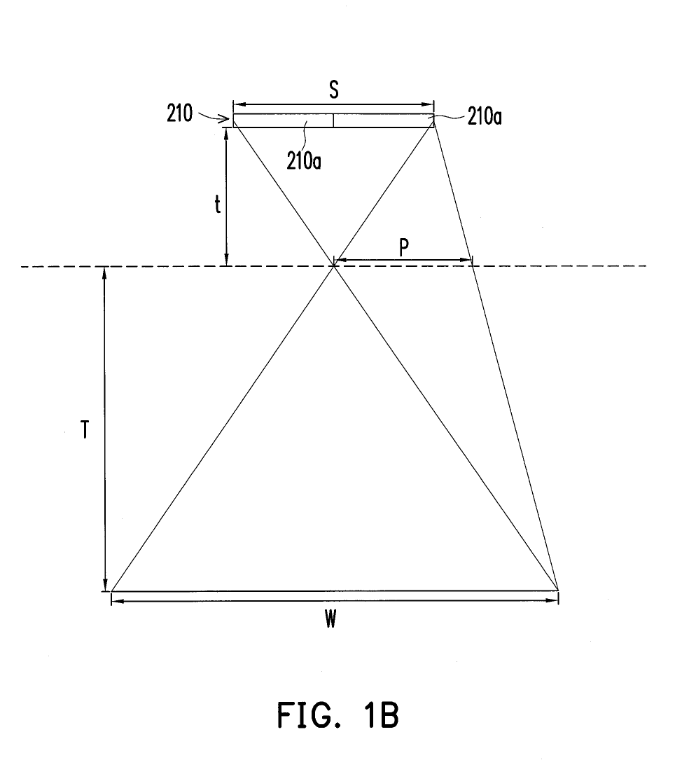

FIG. 1A schematically illustrates an auto-stereoscopic display according to an embodiment of this disclosure. Referring to FIG. 1A, the auto-stereoscopic display 200 of this embodiment is suitable for being viewed by a viewer 202. The auto-stereoscopic display 200 includes a display panel 210 and an adjustable parallax barrier module 220. The adjustable parallax barrier module 220 is disposed between the display panel 210 and the viewer 202. The adjustable parallax barrier module 220 comprises a plurality of parallax barriers 222 stacked upon each other. A distance t between each one of the parallax barriers 222 and the display panel 210 is different from a distance t between the other one of the parallax barriers 222 and the display panel 210. For example, a distance t1 between the parallax barriers 222A and the display panel 210 is different from a distance t2 between the parallax barriers 222B and the display panel 210. One of parallax barriers 222 is selected and enabled based on a distance D between the viewer 202 and the display panel 210. In FIG. 1A, i.e. parallax barrier 222A is selected and enabled.

FIG. 1B schematically illustrates relationship between the display panel and the adjustable parallax barrier module in the auto-stereoscopic display according to an embodiment of this disclosure. Referring to FIG. 1A and FIG. 1B, in the auto-stereoscopic display 200 of this embodiment, one of parallax barriers 222 (i.e. parallax barrier 222A or parallax barrier 222B) is selected and enabled (turned-on) based on a distance D between the viewer 202 and the display panel 210. The position of the selected and enabled parallax barrier satisfies the following equations (1) and (2). In this embodiment, the display panel 210 comprises a plurality of pixels 210a, wherein the total width of two adjacent pixels 210a is S, the distance between the display panel 210 and the enabled parallax barrier 222 in the adjustable parallax barrier module 220 is t, the distance between the viewer 202 and the enabled parallax barrier 222 in the adjustable parallax barrier module 220 is T, and the distance between both eyes of the viewer 202 is W. As shown in FIG. 1B, the width S, the distance t, the distance T, and the distance W satisfy the equation (1): t/T=S/W. Further, the period of the enabled parallax barrier 222 in the adjustable parallax barrier module 220 is P, and the width S, the distance t, the distance T, and the period P satisfy the equation (2): T/(T+t)=P/S. By properly selecting and enabling another one parallax barrier 222 in the adjustable parallax barrier module 220, the distance t is changed when the distance D between the viewer 202 and the display panel 210 changes. Therefore, the viewer 202 may view optimized three dimensional images even though the relative position of the viewer 202 and the display panel 210 changes.

Specifically, the distance W between two eyes of the viewer 202 is about 6.5 centimeters. For example, the total width S of two adjacent pixels 210a is about 166 micrometers because the width of one pixel 210a of the display panel 210 is about 83 micrometers. When the viewer 202 concentrates on the display panel 210, the distance D between the viewer 202 and the display panel 210 is about 50 centimeters. When the viewer 202 views the display panel 210 leisurely, the distance D between the viewer 202 and the display panel 210 is about 100 centimeters. If the distance D varies from 50 centimeters to 100 centimeters, the variation of the distance t between the display panel 210 and the enabled parallax barrier 222 in the adjustable parallax barrier module 220 is about 130 micrometers. In the auto-stereoscopic display 200, the distance t between the display panel 210 and the enabled parallax barrier 222 in the adjustable parallax barrier module 220 can be changed by properly selecting and enabling one of the parallax barriers 222 in the adjustable parallax barrier module 220. The operation mechanism of the adjustable parallax barrier module 220 is described in detail as followings.

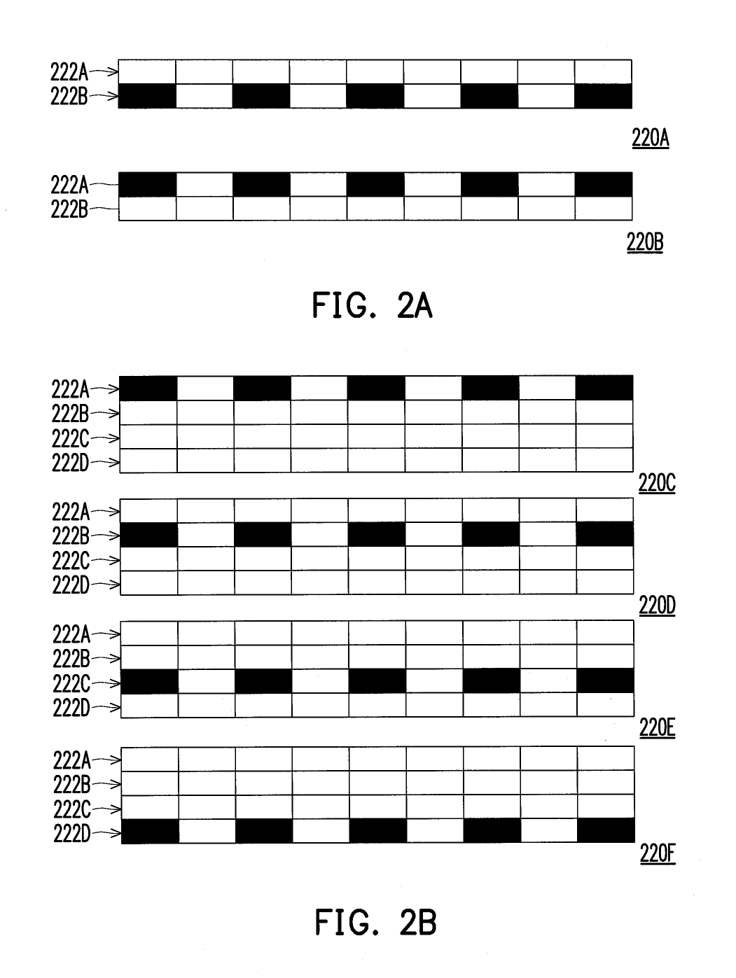

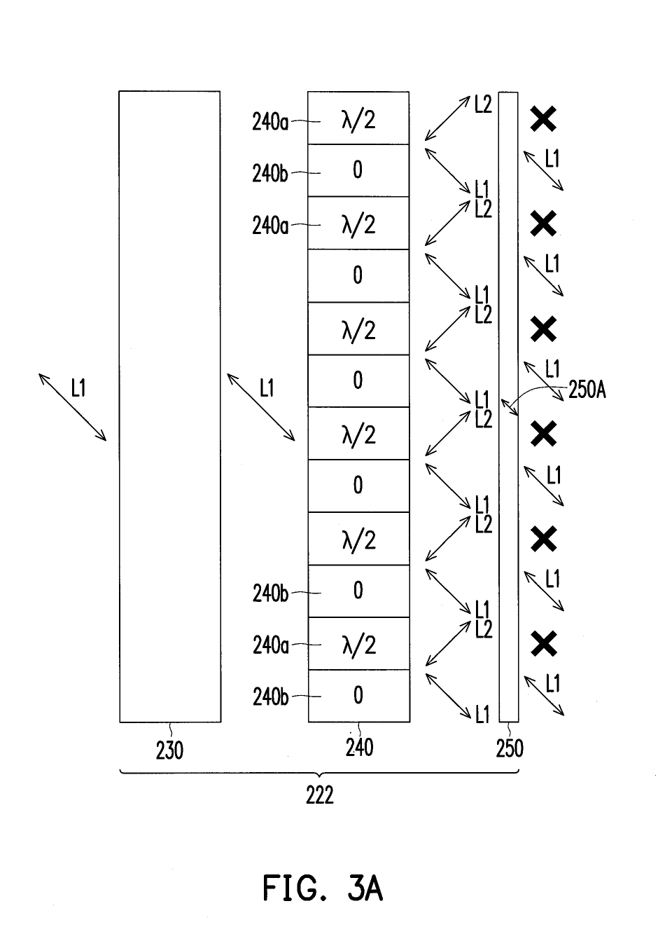

FIG. 2A schematically illustrates an adjustable parallax barrier module according to an embodiment of this disclosure. As shown in FIG. 2A, the adjustable parallax barrier module 220 comprises two parallax barriers 222A and 222B. When the parallax barrier 222B is enabled or activated, the adjustable parallax barrier module 220A is provided, wherein parts regions of the parallax barrier 222B are light-transmissive and the other parts regions of the parallax barrier 222B are opaque. At this time, the parallax barrier 222A is not selected and is light-transmissive. In other words, optical behavior of the light passing through the disabled parallax barrier 222A is not shielded.

When the parallax barrier 222A is enabled or activated, the adjustable parallax barrier module 220B is provided, wherein parts regions of the parallax barrier 222A are light-transmissive and the other parts regions of the parallax barrier 222A are opaque. At this time, the parallax barrier 222B is not selected and is light-transmissive. In other words, optical behavior of the light passing through the disabled parallax barrier 222B is not shielded.

FIG. 2B schematically illustrates an adjustable parallax barrier module according to another embodiment of this disclosure. As shown in FIG. 2B, the adjustable parallax barrier module 220 comprises four parallax barriers 222A, 222B, 222C and 222D. When the parallax barrier 222A is enabled or activated, the adjustable parallax barrier module 220C is provided; when the parallax barrier 222B is enabled or activated, the adjustable parallax barrier module 220D is provided; when the parallax barrier 222C is enabled or activated, the adjustable parallax barrier module 220E is provided; and when the parallax barrier 222D is enabled or activated, the adjustable parallax barrier module 220F is provided. In this embodiment, only one of the parallax barriers 222A, 222B, 222C and 222D is selected and enabled while the others of the parallax barriers 222A, 222B, 222C and 222D is not selected and is disabled.

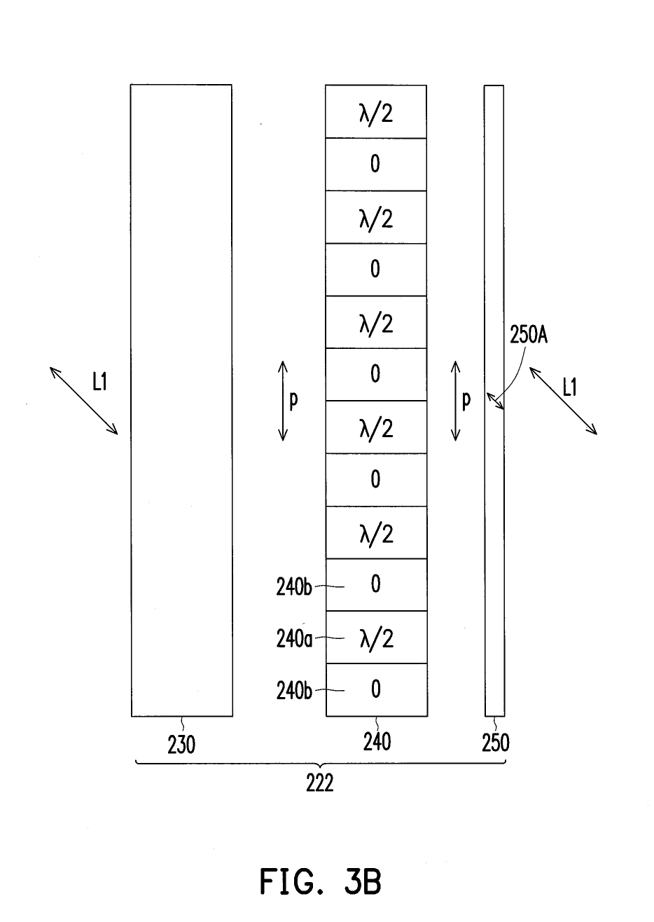

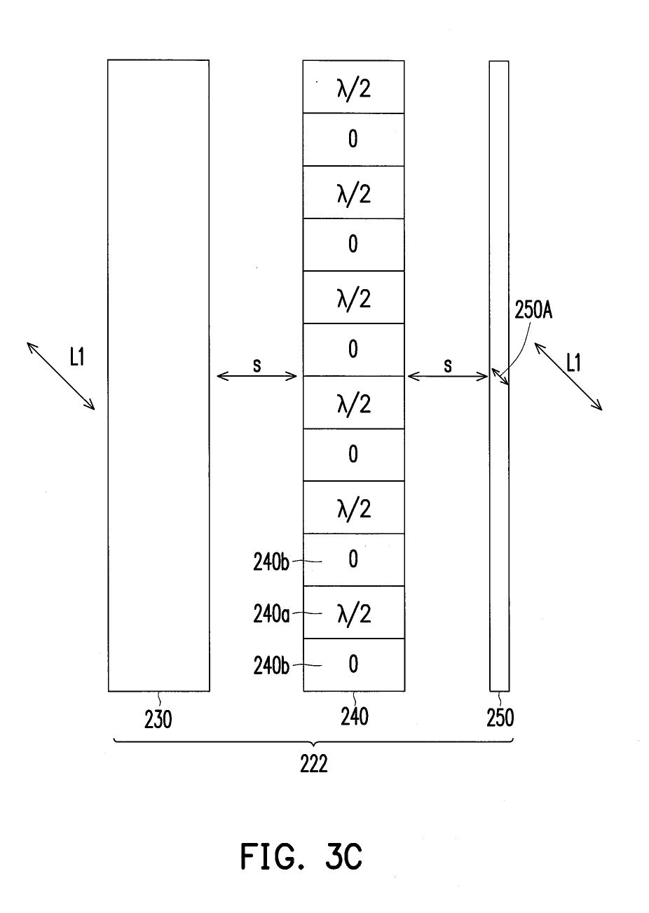

FIG. 3A, FIG. 3B and FIG. 3C are illustrated to explain optical behavior of the light generated from the display panel 210 when passing through an enabled parallax barriers and a disabled parallax barriers.

FIG. 3A schematically illustrates optical behavior of light generated from the display panel when passing through an enabled parallax barrier of the adjustable parallax barrier module. FIG. 3B and FIG. 3C schematically illustrate optical behavior of light generated from the display panel when passing through a disabled parallax barrier of the adjustable parallax barrier module.

Referring to FIG. 3A, FIG. 3B and FIG. 3C, the display panel 210 of this embodiment provides a first linear polarized light L1, wherein an included angle between the polarized direction of the first linear polarized light L1 and the horizontal direction is about 45 degrees. Each parallax barrier 222 of the adjustable parallax barrier module 220 includes a liquid crystal layer 230, a patterned micro-retarder 240 and a polarizer 250. The liquid crystal layer 230 is disposed between the display panel 210 (shown in FIG. 1A) and the patterned micro-retarder 240, wherein the patterned micro-retarder 240 includes a plurality of phase retardation bar-shaped patterns 240a and a plurality of zero retardation bar-shaped patterns 240b, the phase retardation bar-shaped patterns 240a and the zero retardation bar-shaped patterns 240b are arranged alternately, and each of the phase retardation bar-shaped patterns 240a has a phase retardation of λ/2. The patterned micro-retarder 240 is disposed between the liquid crystal layer 230 and the polarizer 250.

Referring to FIG. 3A, when the first linear polarized light L1 generated from the display panel 210 (shown in FIG. 1A) passes through the liquid crystal layer 230 of the enabled parallax barrier 222, the polarization of the first linear polarized light L1 remains. After passing through the liquid crystal layer 230, the first linear polarized light L1 then passes through the patterned micro-retarder 240, part of the first linear polarized light L1 passes through the phase retardation bar-shaped patterns 240a and is converted into a second linear polarized light L2. Another part of the first linear polarized light L1 passes through the zero retardation bar-shaped patterns 240b and is converted into the polarization of the first linear polarized light L1 remains. After the first linear polarized light L1 generated from the display panel 210 passes through the liquid crystal layer 230 and the patterned micro-retarder 240, the alternately arranged first linear polarized light L1 and second linear polarized light L2 are generated. Since the polarized direction of the second linear polarized light L2 is perpendicular to a transmission axis 250A of the polarizer 250, the second linear polarized light L2 is blocked by the polarizer 250 and accordingly light-shielding regions of the parallax barrier 222 are generated. Since the polarized direction of the second linear polarized light L2 is parallel with the transmission axis 250A of the polarizer 250, the first linear polarized light L1 is capable passing through the polarizer 250 and accordingly light-transmissive regions of the parallax barrier 222 are generated. After the first linear polarized light L1 passes through the enabled parallax barrier 222 of the adjustable parallax barrier module 220, the light-shielding regions and the light-transmissive regions of the parallax barrier 222 arranged alternately are generated. Accordingly, the viewer 202 can view three dimensional images provided by the display panel 210.

Referring to FIG. 3B, when the linear polarized light L1 generated from the display panel 210 (shown in FIG. 1A) passes through the liquid crystal layer 230 of the disabled parallax barrier 222 of the adjustable parallax barrier module 220, the polarization of the linear polarized light L1 is converted into a p-type polarized light p (vertical polarized light). The p-type polarized light p is perpendicular to the horizontal direction. After passing through the liquid crystal layer 230, the p-type polarized light p then passes through the patterned micro-retarder 240, the polarization of the p-type polarized light p passes through the phase retardation bar-shaped patterns 240a and the zero retardation bar-shaped patterns 240b remains. Then, weight of the p-type polarized light p parallel with the transmission axis 250A of the polarizer 250 passes through the polarizer 250 since the polarized direction of the p-type polarized light p is not perpendicular to the transmission axis 250A of the polarizer 250.

Referring to FIG. 3C, when the linear polarized light L1 generated from the display panel 210 (shown in FIG. 1A) passes through the liquid crystal layer 230 of the disabled parallax barrier 222 of the adjustable parallax barrier module 220, the polarization of the linear polarized light L1 is converted into an s-type polarized light s (a horizontal polarized light). The s-type polarized light s is parallel with the horizontal direction. After passing through the liquid crystal layer 230, the s-type polarized light s then passes through the patterned micro-retarder 240, the polarization of the s-type polarized light s passes through the phase retardation bar-shaped patterns 240a and the zero retardation bar-shaped patterns 240b remains. Then, the s-type polarized light s partially passes through the polarizer 250 since the polarized direction of the s-type polarized light s is not perpendicular to the transmission axis 250A of the polarizer 250.

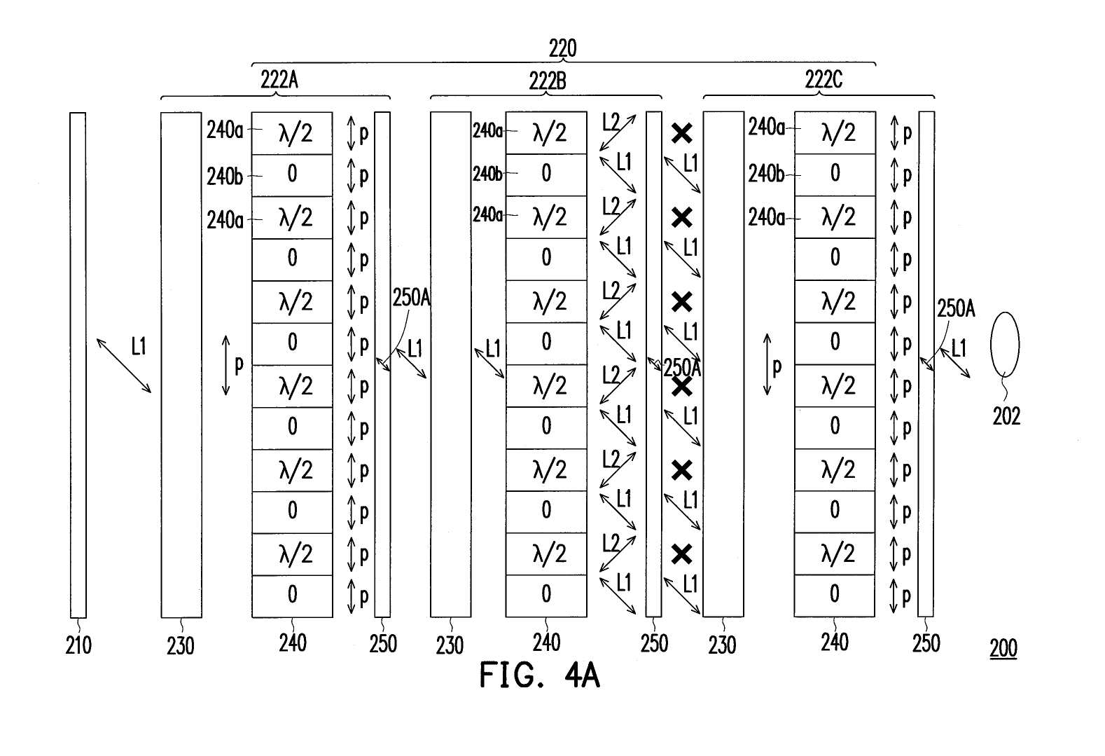

FIG. 4A and FIG. 4B schematically illustrate optical behavior of light generated from the display panel when passing through the adjustable parallax barrier module. As shown in FIG. 4A, the parallax barrier 222B of the adjustable parallax barrier module 220 is selected and enabled based on the distance D between the viewer 202 and the display panel 210, and the parallax barrier 222A, 222C of the adjustable parallax barrier module 220 are disabled. When the first linear polarized light L1 generated from the display panel 210 passes through the disabled parallax barrier 222A, the optical behavior of the first linear polarized light L1 is described in FIG. 3B and the related descriptions. Briefly, the first linear polarized light L1 generated from the display panel 210 is capable of passing through the parallax barrier 222A, since the p-type polarized light p is capable partially passing through the phase retardation bar-shaped patterns 240a and the zero retardation bar-shaped patterns 240b.

The first linear polarized light L1 passing through the parallax barrier 222A then passes through the enabled parallax barrier 222B. The optical behavior of the first linear polarized light L1 is described in FIG. 3A and the related descriptions. Briefly, after the first linear polarized light L1 passing through the parallax barrier 222B, three dimensional images can be viewed by the viewer 202.

The first linear polarized light L1 emitted from the parallax barrier 222B then passes through the disabled parallax barrier 222C. In the disabled parallax barrier 222C, the liquid crystal layer 230 converts the first linear polarized light L1 into p-type polarized light p, then the p-type polarized light p passes through the patterned micro-retarder 240. The detail optical behavior is described in FIG. 3B and the related descriptions. As shown in FIG. 4B, the first linear polarized light L1 emitted from the parallax barrier 222B then passes through the disabled parallax barrier 222C. In the disabled parallax barrier 222C, the liquid crystal layer 230 converts the first linear polarized light L1 into s-type polarized light s, then the s-type polarized light s passes through the patterned micro-retarder 240. The detail optical behavior in the disabled parallax barriers 222A and 222C are described in FIG. 3C and the related descriptions.

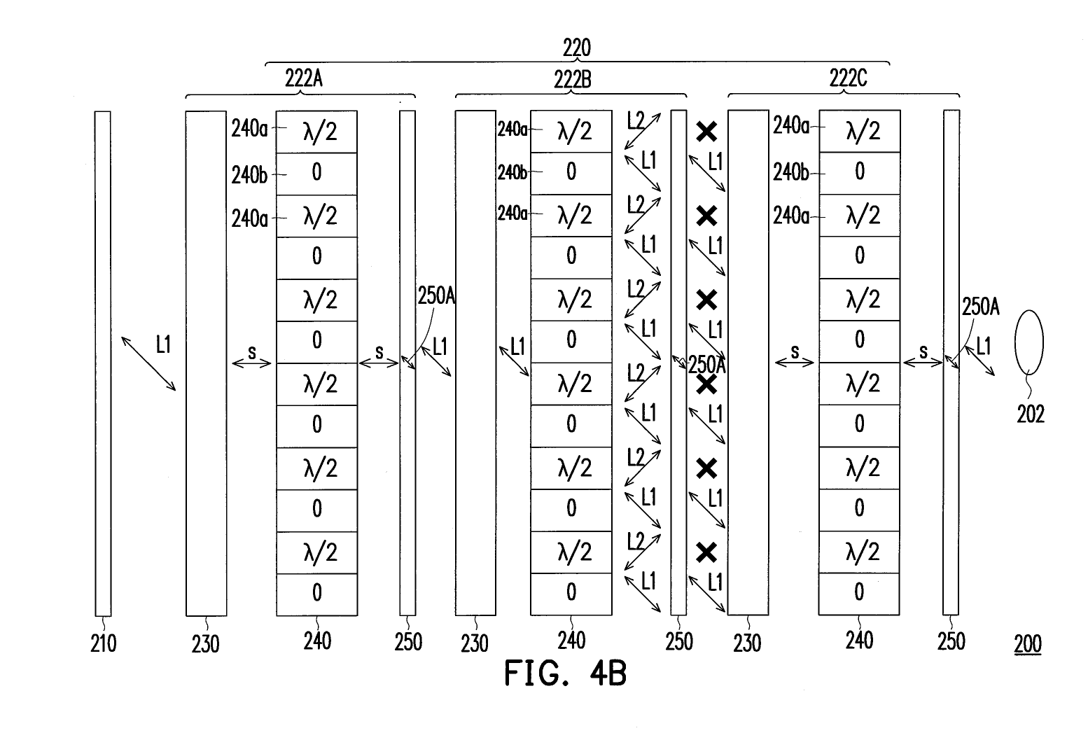

FIG. 5 schematically illustrates an auto-stereoscopic display according to another embodiment of this disclosure. Referring to FIG. 5, in the auto-stereoscopic display 300 of this embodiment, each of the parallax barrier 222A-222C comprises a liquid crystal layer 230 and a polarizer 250. The liquid crystal layer 230 comprises a plurality of regions 232, and each of the regions 232 is capable of providing retardation of λ/2 or 0. Specifically, each of the parallax barriers 222A-222C is capable of locally providing retardation of λ/2 or 0 by controlling of the orientation of liquid crystal material in each of the regions 232. In other words, the parallax barriers 222A-222C are electrical switchable parallax barriers. The regions 232 of the liquid crystal layer 230 can be switched to provide retardation of λ/2 (i.e. the λ/2 retardation pattern 232a) or 0 (i.e. the zero retardation pattern 232b) anytime. In each of the parallax barriers 222A-222C, the polarizer 250 is disposed at a side of the liquid crystal layer 230. In other words, in each of the parallax barriers 222A-222C, the polarizer 250 and the viewer 202 are disposed at the same side of the liquid crystal layer 230.

In the auto-stereoscopic display 300 of FIG. 5, the parallax barrier 222B of the adjustable parallax barrier module 220 is selected and enabled to provide regions 232 having retardation of λ/2 and 0. In addition, the parallax barriers 222A and 222C are disabled and only provide zero retardation. In this embodiment, the display panel 210 provides a first linear polarized light L1. When the first linear polarized light L1 passes through the liquid crystal layer 230 of the parallax barrier 222A, all the regions 232 of the liquid crystal layer 230 are light-transmissive and provide zero retardation. After passing through the liquid crystal layer 230, the first linear polarized light L1 then passes through the polarizer 250. In this embodiment, the polarized light emitted from the display panel 210 can be p-type polarized light p. The polarized direction of the polarized light emitted from the display panel 210 and the orientations of the polarizer 250 can be modified based one design requirements as long as the linear polarized light L1 can partially pass through the parallax barrier 222A.

The parallax barrier 222B is enabled and the liquid crystal layer 230 is driven to provide a plurality of phase retardation patterns 232a and a plurality of zero retardation patterns 232b. The phase retardation patterns 232a and the zero retardation patterns 232b are arranged alternately. For example, each of the phase retardation patterns 232a provides retardation of λ/2. The regions 232 of the liquid crystal layer 230 arranged in odd rows are switched into the phase retardation patterns 232a, and the regions 232 of the liquid crystal layer 230 arranged in even rows are switched into the zero retardation patterns 232b, for instance. As shown in FIG. 5, after the first linear polarized light L1 provided from the display panel 210 passing through the phase retardation patterns 232a arranged in odd rows, the first linear polarized light L1 is converted into a second linear polarized light L2. The second linear polarized light L2 is blocked by the polarizer 250, and the phase retardation patterns 232a serve as light-shielding regions. In addition, after the first linear polarized light L1 provided from the display panel 210 passing through the zero retardation patterns 232b arranged in even rows, the polarization of the first linear polarized light L1 remains. The first linear polarized light L1 passes through the polarizer 250, and the zero retardation patterns 232b serve as light-transmissive regions. Accordingly, after the first linear polarized light L1 passing through the parallax barrier 222B, three dimensional images can be viewed by the viewer 202.

Thereafter, when the first linear polarized light L1 emitted from the parallax barrier 222B passes through the parallax barrier 222C, all the regions 232 of the liquid crystal layer 230 in the parallax barrier 222C are light-transmissive and provide zero retardation.

As mentioned in the aforesaid embodiments, based on the distance D between the viewer 202 and the display panel 210, one of the parallax barriers 222A, 222B and 222C is selected and enabled. Accordingly, no additional mechanical structure is required to adjust the distance between the adjustable parallax barrier module 220 and the display panel 210. More specifically, the adjustable parallax barrier module 220 comprises a plurality of parallax barriers 222 stacked upon each other. The distance t between the display panel 210 and each parallax barrier 222 of the adjustable parallax barrier module 220 can be properly adjusted by thickness of substrate, thickness and quantity of the polarizer 250, thickness and quantity of the patterned micro-retarder 240, and/or thickness and quantity of the liquid crystal layer 230. In this case, the viewer 202 can view optimized three dimensional images.

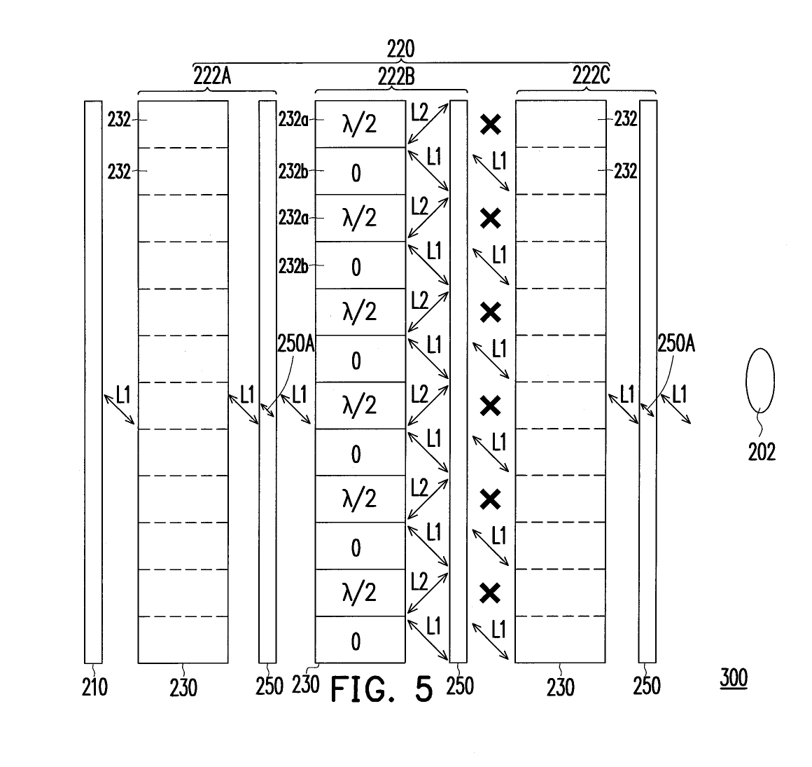

It is noted that the viewer 202 who stay within kite-shaped regions K (shown in FIG. 6) in front of the display panel 210 can view the optimized three dimensional images.

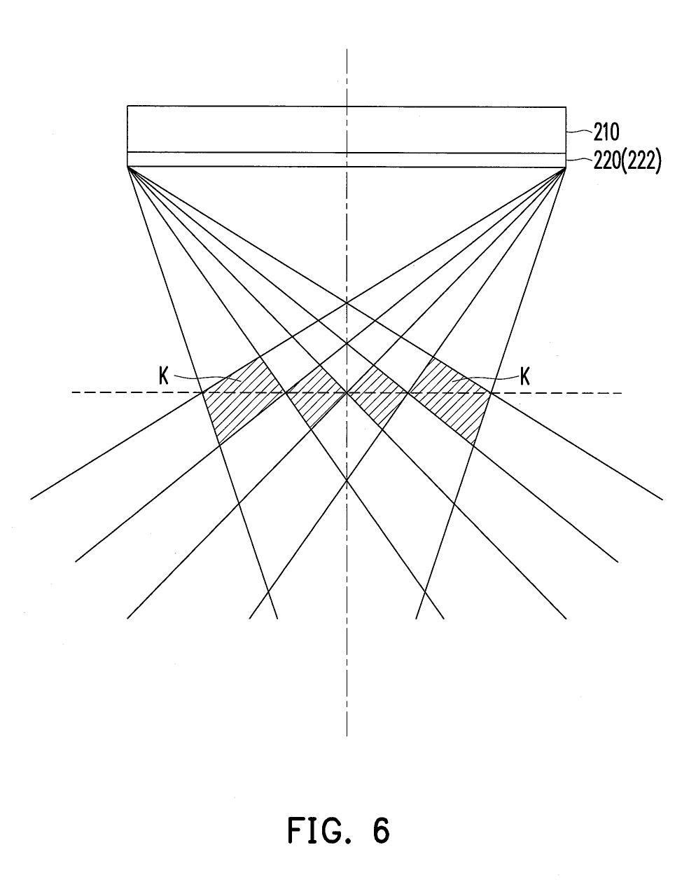

FIG. 7A and FIG. 7B schematically illustrates an auto-stereoscopic display that provides optimized three dimensional images when the viewer moves backwardly. In FIG. 7A and FIG. 7B, the disabled parallax barriers in the adjustable parallax barrier module 220 are omitted, and only the enabled disabled parallax barrier 222 is shown. In this embodiment, the display panel 210 further comprises a backlight module 270.

As shown in FIG. 7A, when the distance D1 between the viewer 202 and the display panel 210 is (T1+t1), the distance between the display panel 210 and the enabled parallax barrier 222 of the adjustable parallax barrier module 220 is t1. As shown in FIG. 7B, when the distance D2 between the viewer 202 and the display panel 210 is (T2+t2), the distance between the display panel 210 and the enabled parallax barrier 222 of the adjustable parallax barrier module 220 is t2. In the auto-stereoscopic display 200, the distance t1, t2 between the display panel 210 and the enabled parallax barrier 222 of the adjustable parallax barrier module 220 can be easily adjusted based on the distance D1, D2, such that the viewer 202 can view the optimized three dimensional images when he moves.

It is noted that the auto-stereoscopic display 200 may further comprise a driving mechanical structure 260 connected to the adjustable parallax barrier module 220. The driving mechanical structure 260 is capable of adjusting the distance between the adjustable parallax barrier module 220 and the display panel 210 precisely.

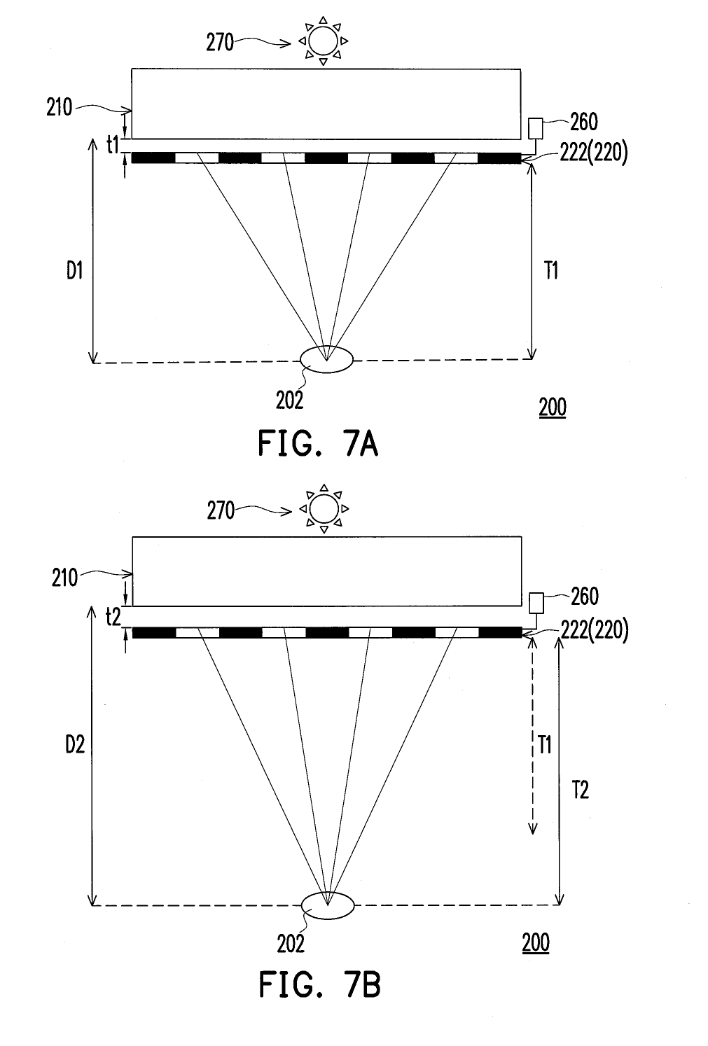

FIG. 8 schematically illustrates a method for fabricating an auto-stereoscopic display according to an embodiment of this disclosure.

Referring to FIG. 8, the method for fabricating the auto-stereoscopic display 200 includes the following steps. In step S300, a display panel 210 is provided first. In step 400, an adjustable parallax barrier module 220 is formed over the display panel 210, wherein the adjustable parallax barrier module 220 comprises a plurality of parallax barriers 222 stacked upon each other.

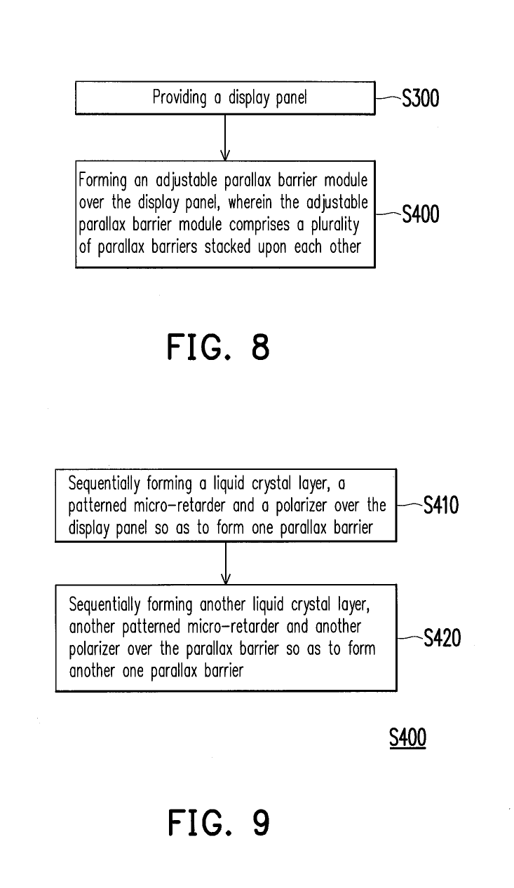

The step 400 is described in detail in accompany with FIG. 9. Referring to FIG. 4 and FIG. 9, in step 410, a liquid crystal layer 230, a patterned micro-retarder 240 and a polarizer 250 are sequentially formed over the display panel 210 so as to form one parallax barrier 222 (e.g. the parallax barrier 222A). In step 420, after the parallax barrier 222A is formed over the display panel 210, another liquid crystal layer 230, another patterned micro-retarder 240 and another polarizer 250 are sequentially formed over the parallax barrier 222A so as to form another one parallax barrier 222 (e.g. the parallax barrier 222B) In this disclosure, the step 420 can be repeated once so as to form one more parallax barriers 222C over the parallax barrier 222B.

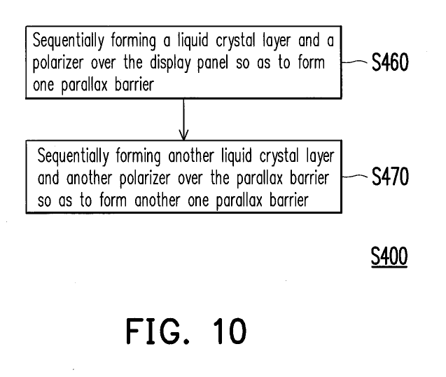

The step 400 is also described in detail in accompany with FIG. 10. Referring to FIG. 5 and FIG. 10, in the step 460, a liquid crystal layer 230 and a polarizer 250 are sequentially formed over the display panel 210 so as to form one parallax barrier 222 (e.g. the parallax barrier 222A). In step 470, after the parallax barrier 222A is formed over the display panel 210, another liquid crystal layer 230 and another polarizer 250 are sequentially formed over the parallax barrier 222A so as to form another one parallax barrier 222 (e.g. the parallax barrier 222B). In this disclosure, the step 470 can be repeated once so as to form one more parallax barriers 222C over the parallax barrier 222B.

It is noted that the method for fabricating the auto-stereoscopic display 200 may further comprise providing a driving mechanical structure 260 connected to the adjustable parallax barrier module 220, wherein the driving mechanical structure 260 is capable of adjusting the distance between the adjustable parallax barrier module 220 and the display panel 210 precisely.

In the disclosure, the distance between the display panel and the parallax barrier is adjustable based on the distance between the viewer and the display panel, such that optimized three dimensional images are viewed by the viewer even though the relative position of the viewer and the auto-stereoscopic display changes. Furthermore, a method for fabricating the above-mentioned auto-stereoscopic displays is also provided in this disclosure.

Although the disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. An auto-stereoscopic display suitable for being viewed by a viewer, the auto-stereoscopic display comprising:
a display panel; and
an adjustable parallax barrier module, disposed between the display panel and the viewer, the adjustable parallax barrier module comprising a plurality of parallax barriers stacked upon each other, wherein distances between each one of the parallax barriers and the display panel are different, and one of parallax barriers is enabled based on a distance between the viewer and the display panel.

2. The auto-stereoscopic display of claims 1, wherein the display panel comprises a plurality of pixels, a total width of two adjacent pixels is S, the distance between the display panel and the enabled parallax barrier in the adjustable parallax barrier module is t, the distance between the viewer and the enabled parallax barrier in the adjustable parallax barrier module is T, the distance between both eyes of the viewer 202 is W, and the width S, the distance t, the distance T, and the distance W satisfy the equation (1):
t/T=S/W.

3. The auto-stereoscopic display of claims 1, wherein the display panel comprises a plurality of pixels, a total width of two adjacent pixels is S, the distance between the display panel and the enabled parallax barrier in the adjustable parallax barrier module is t, a period of the enabled parallax barrier in the adjustable parallax barrier module is P, the distance between the viewer and the enabled parallax barrier in the adjustable parallax barrier module is T, and the width S, the distance t, the distance T, and the period P satisfy the equation (2):
T/(T+t)=P/S.

4. The auto-stereoscopic display of claim 1, wherein each of the parallax barriers of the adjustable parallax barrier module comprises:
a liquid crystal layer;
a patterned micro-retarder, the liquid crystal layer being disposed between the display panel and the patterned micro-retarder, wherein the patterned micro-retarder comprises a plurality of phase retardation bar-shaped patterns and a plurality of zero retardation bar-shaped patterns, the phase retardation bar-shaped patterns and the zero retardation bar-shaped patterns are arranged alternately, and each of the phase retardation bar-shaped patterns has a phase retardation of λ/2; and
a polarizer, wherein the patterned micro-retarder is disposed between the liquid crystal layer and the polarizer.

5. The auto-stereoscopic display of claim 4, wherein the display panel provides a first linear polarized light capable of passing through the liquid crystal layer of the enabled parallax barrier without changing its polarization; in the enabled parallax barrier, part of the first linear polarized light passing through the phase retardation bar-shaped patterns and is converted into a second linear polarized light and is blocked by the polarizer, and the other part of the first linear polarized light passing through the zero retardation bar-shaped patterns passes the polarizer.

6. The auto-stereoscopic display of claim 4, wherein the display panel provides a first linear polarized light, the first linear polarized light is converted into a vertical polarized light after passing through the liquid crystal layer, and after passing through the phase retardation bar-shaped patterns and the zero retardation bar-shaped patterns, weight of the vertical polarized light parallel with the transmission axis of the polarizer passes through the polarizer.

7. The auto-stereoscopic display of claim 4, wherein among the disabled parallax barrier, the display panel provides a first linear polarized light, the first linear polarized light is converted into a horizontal polarized light after passing through the liquid crystal layer, and after passing through the phase retardation bar-shaped patterns and the zero retardation bar-shaped patterns, weight of the horizontal polarized light which are parallel with the transmission axis of the polarizer passes through the polarizer.

8. The auto-stereoscopic display of claim 1, wherein each of the parallax barriers of the adjustable parallax barrier module comprises:
a liquid crystal layer comprising a plurality of regions, each of the regions being capable of providing a retardation of λ/2 or zero retardation; and
a polarizer, disposed at a side of the liquid crystal layer, wherein the polarizer and the viewer are disposed at the same side of the liquid crystal layer.

9. The auto-stereoscopic display of claim 8, wherein the liquid crystal layer in the enabled parallax barrier comprises a plurality of phase retardation bar-shaped patterns and a plurality of zero retardation bar-shaped patterns, the phase retardation bar-shaped patterns and the zero retardation bar-shaped patterns are arranged alternately, and each of the phase retardation bar-shaped patterns has a phase retardation of λ/2, the display panel provides a first linear polarized light, the first linear polarized light is converted into a second linear polarized light perpendicular to the first linear polarized light by the phase retardation bar-shaped patterns, the second linear polarized light is blocked by the polarizer, and the first linear polarized light which passed through the zero retardation bar-shaped patterns pass through the polarizer.

10. The auto-stereoscopic display of claim 8, wherein all regions of the liquid crystal layer in the disabled parallax barrier provide zero retardation, and a first linear polarized light provided by the display panel passes through the liquid crystal layer and the polarizer.

11. The auto-stereoscopic display of claim 1, further comprising a driving mechanical structure, connected to the adjustable parallax barrier module, wherein the driving mechanical structure is capable of adjusting the distance between the adjustable parallax barrier module and the display panel.

12. A method for fabricating an auto-stereoscopic display, comprising:
providing a display panel; and
forming an adjustable parallax barrier module over the display panel, wherein the adjustable parallax barrier module comprises a plurality of parallax barriers stacked upon each other.

13. The method of claim 12, wherein a method for forming the adjustable parallax barrier module comprises:
forming a liquid crystal layer, a patterned micro-retarder and a polarizer over the display panel sequentially to form a parallax barrier; and
forming another liquid crystal layer, another patterned micro-retarder and another polarizer over the parallax barrier sequentially to form another parallax barrier.

14. The method of claim 12, wherein a method for forming the adjustable parallax barrier module comprises:
forming a liquid crystal layer and a polarizer over the display panel sequentially to form a parallax barrier; and
forming another liquid crystal layer and another polarizer over the parallax barrier sequentially to form another parallax barrier.

15. The method of claim 12, further comprising providing a driving mechanical structure connected to the adjustable parallax barrier module, wherein the driving mechanical structure is capable of adjusting the distance between the adjustable parallax barrier module and the display panel.
